(19) United States
(12) Patent Application Publication
(10) Pub. No.: US 2005/0057102 A1
(43) Pub. Date: Mar. 17, 2005

(54) Holding member, coolant, cooling method and cooling device, linear motor device, stage device, and exposure apparatus

(75) Inventors: Masahiro Totsu, Kumagaya city (JP); Andrew J. Hazelton, San Carlos, CA (US); Ed E. Reynolds, Foster City, CA (US); Michael B. Binnard, Belmont, CA (US); Yoichi Arai, Belmont, CA (US)

Correspondence Address: OLIFF & BERRIDGE, PLC, P.O. BOX 19928, ALEXANDRIA, VA, 22320, US

(73) Assignee: NIKON CORPORATION, Chiyoda-ku (JP)

(21) Appl. No.: 10/659,401

(22) Filed: Sep. 11, 2003

(51) Int. Cl. H02K 41/00; H02K 9/00

(52) U.S. Cl. 310/12; 310/54; 310/58

(57) ABSTRACT

A coolant cools an object (such as, for example, a coil of a linear motor that drives a stage of an exposure apparatus) while suppressing the generation of a temperature distribution in various parts of the object being cooled by using a coolant that includes a first component and a second component dispersed in the first component, the second component increases in temperature by a lesser amount than the first component when a predetermined amount of heat is absorbed by the first and second components, respectively. The second component may be a substance that changes phase (for example, from a solid to a liquid or from a liquid to a gas) in order to absorb the predetermined amount of heat. The second component may have a higher heat capacity than the first component, and may not change phase when it absorbs heat to cool the object.

### BACKGROUND OF THE INVENTION

1. Field of Invention

This invention relates to a holding member, a coolant, a cooling method, a cooling device, a linear motor device, a stage device, and an exposure apparatus.

2. Description of Related Art

A micro device such as, for example, a semiconductor element, a liquid crystal display element, or the like is manufactured by a photolithography method which transfers a pattern formed on a mask onto a photosensitive substrate. An exposure apparatus used in this photolithography process has a mask stage that supports and two-dimensionally moves a mask and a substrate stage that supports and two-dimensionally moves a substrate, and transfers a pattern formed on the mask onto a substrate via a projection optical system by consecutively moving the mask stage and the substrate stage. Batch type exposure apparatus, which simultaneously transfer an entire pattern of a mask onto a substrate, and scanning type exposure apparatus, which continuously transfer a pattern of a mask onto a substrate by synchronously scanning a mask stage and a substrate stage are known types of exposure apparatus. In either type of exposure apparatus, a mask and a substrate must be aligned with high accuracy in order to accurately transfer the pattern on the mask pattern to the substrate. Therefore, positioning accuracy of a mask stage and a substrate stage is a very important performance capability of an exposure apparatus.

Conventionally, a linear motor is used as a driving source of the substrate stage and mask stage (hereafter both will be referred to as “stage”), but the heat generated by the linear motor affects the positioning of the stages and thus, decreases the accuracy of the stage positions. For example, the heat generated by a linear motor thermally deforms the surrounding members and devices and also, for example, causes the air temperature to change on an optical path of an optical interference measuring instrument (interferometer) used for detecting a stage position, which causes errors in measurement values. Therefore, in order to help prevent the heat generated by a linear motor from being transmitted to surrounding parts, conventionally, coils of a linear motor are housed in a housing and coolant is supplied into the housing. This type of linear motor has an entrance through which coolant enters into the housing and an exit from which coolant exits the housing. The coolant which is supplied from the entrance and flows inside the housing, collects the heat from the coils, and then exits to the outside of the housing.

However, the following problems occur in the above-described conventional linear motor.

As described above, the coolant supplied into the housing exits outside the housing after absorbing the heat from the coils, so the coolant has a higher temperature when it exits the housing than when it entered the housing. Accordingly, there is a temperature difference between the coolant which enters the housing and the coolant which exits the housing because the coolant, while flowing in the housing, absorbs the heat from the coils, and thus, the coolant which exits the housing has a higher temperature than the coolant which enters the housing. Due to this temperature difference, problems arise. For example, as discussed above, the temperature difference causes air to fluctuate inside a device and thus, reduces the measurement accuracy of an optical interference measuring instrument. In addition, members or the like in the vicinity of the exit are thermally deformed (thermal expansion).

### SUMMARY OF THE INVENTION

This invention addresses the above-mentioned problems. One object of this invention is to provide a holding member, a coolant, a cooling method, a cooling device, a linear motor device, a stage device, and an exposure apparatus which can substantially reduce and, preferably eliminate, the generation of a temperature difference among at least a part of an object, when cooling an object such as, for example, a coil stored in a housing.

One aspect of this invention provides a holding member which includes pores and/or a hollow part, and a cooling substance, which is held in the pores and/or the hollow part and absorbs an amount of heat when the cooling substance undergoes a phase change between at least two of a solid phase, a liquid phase, and a gas phase.

Another aspect of this invention provides a coolant having the above-mentioned holding member dispersed in a specified liquid. Thus, an object can be cooled by latent heat when a cooling substance held by the holding member changes phase and the generation of a temperature distribution in each position of an object affected by the coolant can be controlled and a suitable cooling effect can be obtained. Furthermore, a cooling substance can be held, for example, in the pores of the holding member or in a hollow part of the holding member, so the cooling substance can be transferred while it is in any desired initial phase within the holding member. For example, the cooling substance can be transferred while in a liquid phase because the cooling substance is held in the holding member. In addition, the cooling substance can be transformed into its initial phase or any desired phase while it is within the holding member and thus, for example, can be reused.

One aspect of this invention provides a holding member, the internal pressure of which is set based on a target phase change temperature of the cooling substance. By so doing, a cooling substance can change phase at an arbitrary temperature corresponding to an internal pressure which has been set, so the object is cooled to a desired temperature by this cooling substance.

One aspect of this invention provides a coolant having the above-mentioned holding member dispersed in a liquid formed of a material which is different from the cooling substance. According to this aspect of the invention, a temperature at which a phase of the cooling substance changes can be set at a different value with respect to a temperature of a liquid, so by selecting a type of cooling substance according to a target cooling temperature, a cooling operation of an object can be performed without increasing the temperature of the liquid.

One aspect of this invention provides a holding member which is formed of magnetic material. This aspect of the invention provides a holding member which is formed, at least partially, of a magnetic body. By so doing, the holding member can be easily collected and/or separated from the surrounding environment by a magnetic force.

An aspect of this invention provides a holding member having a cooling substance which is a gel cooling substance. By so doing, a cooling substance can be easily handled. The gel may have dispersed within it a material that changes phase in order to absorb heat (for example, particles of water/ice). Alternatively, or in addition, the material selected as the gel can have a heat capacity (i.e., the amount of heat a given amount of a substance can absorb so as to produce a predetermined amount of temperature increase (e.g., 1 degree Celsius) in the substance) that is higher than the heat capacity of the coolant liquid in which the holding member containing the gel is mixed. For example, if the holding members are mixed in water, the gel contained in the holding members would have a heat capacity that is higher than the heat capacity of the water. Thus, the gel would absorb most of the heat generated by the motor coils, while the coolant temperature would increase by an amount that is much less than what would occur if water alone were used.

An aspect of this invention provides a holding member that holds a cooling substance which absorbs an amount of heat by undergoing a phase change between at least two of a solid phase, a liquid phase, and a gas phase, wherein the holding member is provided with an internal space for at least holding the cooling substance, and a through-hole which connects an outside of the holding member and the internal space of the holding member.

An aspect of this invention provides a coolant having the above-mentioned holding member dispersed in a specified liquid. According to this aspect of the invention, an object is cooled by latent heat that results when a cooling substance which is held by the holding member changes phase, so the cooling substance can cool the object without increasing the temperature of the cooling substance. Therefore, generation of a temperature distribution in each position of an object can be controlled, and a suitable cooling effect can be obtained. Additionally, a cooling substance is held by a holding member, so it can be easily transferred in any state in which it is held by the holding member.

An aspect of this invention provides a holding member which has an internal space that is a hollow part formed inside the holding member and the internal space holds the cooling substance. According to this aspect of the invention, a cooling substance can be easily transferred, via the holding member, while it is in any state. The holding member can be formed, for example, of a porous body. Thus, the holding member can hold the cooling substance inside the pores of the porous body.

An aspect of this invention provides a holding member having a through-hole, and which is dispersed in a liquid formed of the same material as the cooling substance. According to this aspect of the invention, when a phase of a cooling substance, held by a holding member changes, the cooling substance can, for example, be removed and/or separated from the holding member. More specifically, if the cooling substance is held within an internal hollow part of the holding member, the cooling substance can be removed from the holding member via a through-hole, for example, and an object can be cooled without increasing the temperature of the liquid in which the holding member was dispersed.

An aspect of this invention provides a cooling method for cooling an object by using a coolant having a holding member, filled with a cooling substance, which is dispersed in a specified liquid. According to this method, a cooling substance can be easily transferred in a liquid, via the holding member, while the cooling substance is in any desired state and/or phase. Furthermore, this method can be used to cool each position of an object which can be exposed to the holding member and the specified liquid.

An aspect of this invention provides a cooling method for cooling an object by using a coolant in which a holding member holding a cooling substance in an internal space, which is in communication with an outside of the holding member, is dispersed in a specified liquid. According to this method, a cooling substance can be easily transferred while the cooling substance is in any desired state, such as, for example, in a liquid state, via the holding member. Furthermore, a cooling substance performs heat exchange with a surrounding liquid with respect to an internal space of a holding member and gives a desired cooling effect in each position of an object.

An aspect of this invention provides a cooling method which cools an object by using a coolant, the coolant including a cooling substance existing in two or more different ones of a solid state, a liquid state, and a gaseous state, and the cooling is performed by absorbing heat of the object while the cooling substance undergoes a state change. According to this method, an object is cooled by latent heat when a phase of a cooling substance changes, so a cooling substance cools an object without increasing in temperature. Therefore, generation of a temperature distribution in each position of an object is avoided, and a suitable cooling effect can be obtained.

An aspect of this invention provides a coolant having a cooling substance dispersed in a liquid and some of the cooling substance is in the liquid (liquid substance) state and some of the cooling substance is in the solid (solid substance) state. Furthermore, the coolant absorbs heat of an object when the coolant is changed from, for example, a solid state to a liquid state. According to this method, an object is effectively cooled by significant latent heat when the cooling substance changes from a solid state to a liquid state.

An aspect of this invention provides a cooling system with a cooling device which cools an object using a coolant including a cooling substance that is provided with a mixing device. The mixing device mixes the cooling substance in a liquid state (liquid substance) with the cooling substance in a solid state (solid substance), and a supply device supplies the coolant generated in the mixing device to the object. According to this aspect of the invention, the respective liquid and solid cooling substances are mixed by a mixing device, and a generated coolant is supplied to an object by a supply device; therefore, the coolant can effectively cool an object by latent heat when it changes from a solid state to a liquid state. Thus, a temperature increase of a coolant is not generated when an object is cooled, so generation of a temperature distribution at various positions of an object is suppressed, and a suitable cooling effect can be obtained.

An aspect of this invention provides a cooling system with a solidifying device, which solidifies the cooling substance in the liquid state (liquid substance). According to this aspect of the invention, a liquid cooling substance is converted to a solid cooling substance by re-solidifying the cooling substance using the solidifying device and can then be re-used, in order to cool an object by absorbing heat from the object.

An aspect of this invention provides a cooling device for cooling an object that has a coolant in which a holding member, filled with a cooling substance, is dispersed in a specified liquid, a mixing device, which mixes the liquid with the holding member, and a supply device, which supplies the coolant generated in the mixing device to the object. According to this aspect of the invention, the holding member in which a cooling substance is filled is dispersed in a liquid and becomes a coolant, and the cooling substance in the generated coolant can be easily transferred, via a holding member, while it is in a liquid state. Therefore, a coolant can give a suitable cooling effect at each position of an object.

An aspect of this invention provides a cooling device which cools an object by using a coolant, comprising a holding member, holding a cooling substance in an internal space that is in communication with an outside, which is dispersed in a specified liquid, is provided with a mixing device, which mixes the liquid with the holding member, and a supply device, which supplies the coolant generated in the mixing device to the object. According to this aspect of the invention, the holding member holding the cooling substance is dispersed in a liquid and becomes a coolant, and while heat exchange is performed in the liquid, the cooling substance in the generated coolant can be easily transferred within the liquid and an object can be effectively cooled.

An aspect of this invention provides a cooling system that is provided with a collecting device, which collects the holding members. According to this aspect of the invention, the holding members collected by the collecting device can be re-used in order to cool an object. Additionally, the cooling system is provided with a solidifying device, which solidifies the coolant substance filled in the holding member. Accordingly, a cooling substance held by a holding member and which has been changed to a liquid state by absorbing heat of an object is converted to a solid state and is re-used in order to cool an object. Furthermore, the cooling system can be provided with a collecting device that can include a filter. According to this aspect of the invention, the holding member can be collected by a filter. In addition, the cooling system can be provided with an agitating device, which agitates the coolant which is supplied by the supply device. Accordingly, even if the densities between the liquid and the holding member are different, by agitating a coolant using an agitating device, the holding member in the coolant is supplied to an object in a state in which it is substantially uniformly dispersed in the liquid. Therefore, an object is substantially uniformly cooled.

An aspect of this invention provides a linear motor device having a housing with an internal space and a coil arranged in the internal space and which is provided with a cooling device which cools the coil by a coolant including a cooling substance. The cooling device is provided with a mixing device, which mixes the cooling substance in a liquid state (liquid substance) with the cooling substance in a solid state (solid substance), and a supply device, which supplies the coolant generated in the mixing device to the object. According to this aspect of the invention, coils can be effectively cooled by latent heat when a cooling substance changes from a solid state to a liquid state. Therefore, a temperature increase of the coolant is not generated when coils are cooled, so generation of a temperature distribution in each position of a linear motor device is controlled, and a suitable cooling effect can be obtained.

An aspect of this invention provides linear motor devices, as described above, and a mixing device, which sets a mixing ratio of the cooling substance in the liquid state (liquid substance) and the cooling substance in the solid state (solid substance) according to an amount of heat generated and/or existing in the surrounding of the cooling substance. For example, the mixing device, according to this aspect of the invention, sets a mixing ratio of the cooling substance in the liquid state (liquid substance) and the cooling substance of the solid state (solid substance) according to an amount of heat generated by the coil. According to this aspect of the invention, the amount of a solid cooling substance which cools the surrounding, for example, the coils, to a desired temperature can be set at a minimum, and the coolant can maintain suitable flowability. That is, for example, with respect to coils with a small heating amount, even if the ratio of a solid coolant substance is set small, the coolant can cool an object without increasing the temperature of the cooling substance. In this case, because the ratio of a solid cooling substance is small, the coolant has sufficient flowability and smoothly moves in an internal space of the housing. Meanwhile, with respect to the coils with large heating amount, by setting the ratio of a solid cooling substance large, the coolant can cool the coils to a desired temperature without increasing the temperature of the cooling substance.

An aspect of this invention provides a linear motor device in which a plurality of coils are aligned in a specified direction, the housing is provided with an entrance which is arranged at one end portion of the specified direction and through which the coolant enters, an exit which is arranged at another end portion of the specified direction and through which the coolant exits, and a mixing device which sets the mixing ratio of the cooling substance of the liquid state (liquid substance) and the cooling substance of the solid state (solid substance) according to the distance between the entrance and the exit. According to this aspect of the invention, the coolant can cool each position in a specified direction of an internal space of the housing in a state where suitable flowability is maintained without increasing in temperature due to latent heat when the cooling substance changes from a solid state to a liquid state. That is, when the distance between the entrance and the exit is long, by setting a ratio of a solid cooling substance large, a solid cooling substance can be made to exit at each position in a specified direction of an internal space of the housing, and a desired cooling effect can be obtained. Meanwhile, when the distance between the entrance and the exit is short, even if the ratio of a solid cooling substance is set small, the coolant can cool with a desired cooling effect at each position in a specified direction of an internal space of the housing in a state where sufficient flowability is maintained without increasing the temperature.

An aspect of this invention provides a linear motor device, having a housing with an internal space and a coil arranged in the internal space, that is provided with a cooling device which cools an object by using a coolant in which a holding member filled with a cooling substance is dispersed within a specified liquid, and the cooling device is provided with a mixing device, which mixes the liquid with the holding member, and a supply device, which supplies the coolant generated by the mixing device to the object. According to this aspect of the invention, coils can be effectively cooled by a cooling substance held by a holding member. Furthermore, a cooling substance can be smoothly transferred to an internal part of the housing by a supply device in a state in which it is held by the holding member.

An aspect of this invention provides a linear motor device, having a housing with an internal space and a coil arranged in the internal space, that is provided with a cooling device which cools an object by using a coolant in which a holding member holding a cooling substance is dispersed within a specified liquid, and the cooling device is provided with a mixing device, which mixes the liquid with the holding member, and a supply device, which supplies the coolant generated in the mixing device to the object. According to this aspect of the invention, the coils can be effectively cooled by a cooling substance held by a holding member. Additionally, a cooling substance can be smoothly transferred to an internal part of the housing by a supply device in a state in which it is held by a holding member.

An aspect of this invention provides a linear motor device having a solidifying device, which solidifies the cooling substance filled in the holding member. That is, even when a cooling substance, held by a holding member is, for example, in a solid state and is converted to a liquid state by absorbing heat of coils, a liquid cooling substance can be re-converted to a solid state by a solidifying device, and this cooling substance can be re-used.

An aspect of this invention provides stage devices with the linear motor device described above as a driving device.

An aspect of this invention provides an exposure apparatus provided with a mask stage for holding a mask and a substrate stage for supporting a substrate, and the stage device described above is used for at least one of the mask stage and the substrate stage. According to this aspect of the invention, the generation of the temperature distribution in linear motor device(s) can be suppressed, so the generation of measuring errors of an optical interference measuring instrument and thermal deformation of each member/device in the vicinity of the linear motor device can be suppressed, and a stage device with high positioning accuracy and an exposure apparatus with high exposure accuracy can be provided.

### BRIEF DESCRIPTION OF THE DRAWINGS

This invention will be described with reference to exemplary embodiments illustrated in the attached drawings, in which:

FIG. 1 is a schematic structural diagram showing one embodiment of an exposure apparatus provided with a stage device of this invention;

FIG. 2 is a schematic perspective view showing a mask stage according to one embodiment of this invention;

FIG. 3 is a schematic perspective view showing a substrate stage according to one embodiment of this invention;

FIG. 4 is a schematic perspective view showing one embodiment of a linear motor device of this invention;

FIG. 5 is a schematic perspective view showing a first embodiment of a linear motor device and a cooling device of this invention;

FIGS. 6(a), 6(b) and 6(c) are diagrams explaining a state in which a mixing ratio of solid and liquid cooling substances is set according to a distance between an entrance and an exit of a linear motor device according to this invention;

FIG. 7 is a schematic structural diagram showing a second embodiment of a linear motor device and a cooling device of this invention;

FIG. 8(a) is an outer view showing the first embodiment of a holding member of this invention, and FIG. 8(b) is a cross-sectional view of FIG. 8(a);

FIGS. 9(a) and 9(b) are diagrams showing one example of a method of manufacturing a holding member according to this invention;

FIG. 10(a) is an outer view showing a second embodiment of a holding member of this invention, and FIG. 10(b) is a cross-sectional view of FIG. 10(a);

FIG. 11(a) is an outer view showing a third embodiment of a holding member of this invention, and FIG. 11(b) is a cross-sectional view of FIG. 11(a); and

FIG. 12 is a flowchart showing an example of a method of manufacturing a semiconductor device.

### DETAILED DESCRIPTION OF PREFERRED EMBODIMENTS

The following explains, with reference to the drawings, a linear motor device, a stage device, and an exposure apparatus having a cooling system of exemplary embodiments of this invention.

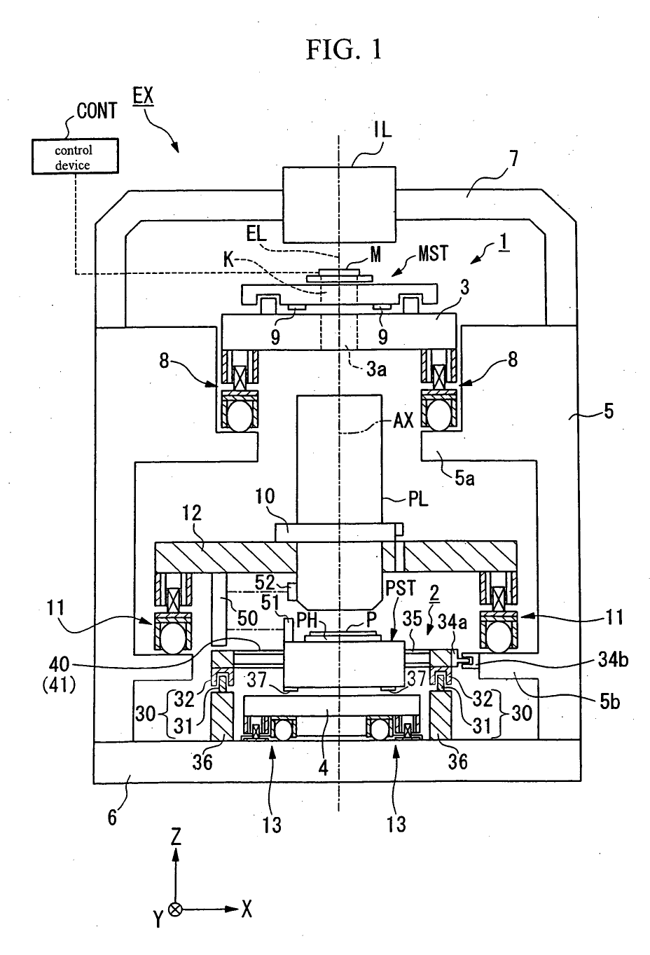

FIG. 1 is a schematic structural diagram showing an embodiment of an exposure apparatus provided with a linear motor device and a stage device of this invention. An exposure apparatus EX in this embodiment is a so-called scanning stepper which transfers a pattern on a mask via a projection optical system PL while synchronously moving the mask M and a photosensitive substrate (substrate) P. In the following explanation, the direction matching an optical axis AX of the projection optical system PL is the Z axis direction, the synchronized movement direction (scanning direction) within a plane perpendicular to the Z axis direction is the Y axis direction, and the direction (non-scanning direction) perpendicular to the Z axis direction and the Y axis direction is the X direction. Additionally, rotational directions about X, Y, and Z axes are θX, θY, and θZ directions, respectively. Furthermore, the words “photosensitive substrate” include a semiconductor wafer coated by a resist and the word “mask” includes a reticle in which a device pattern to be reduced and projected onto a photosensitive substrate is formed.

In FIG. 1, the exposure apparatus EX is provided with a stage device 1 having a mask stage MST, which holds and moves the mask M and a mask holding plate 3, which supports this mask stage MST. The exposure apparatus is also provided with an illumination optical system IL, which has a light source for illuminating the mask M supported by the mask stage MST with the exposure light EL and a stage device 2 having a substrate stage PST which holds and moves the photosensitive substrate P. The exposure apparatus is also provided with a substrate holding plate 4 which supports this substrate stage PST, a projection optical system PL, which projects a pattern image of the mask M which is illuminated by exposure light EL onto the photosensitive substrate P. The photosensitive substrate P is supported by the substrate stage PST and the exposure apparatus EX is also provided with a reaction frame 5 which supports the stage device 1 and the projection optical system PL, and a control device (CONT) which batch-controls an operation of the exposure apparatus EX. The reaction frame 5 is arranged on a base plate 6 which is mounted horizontally to a floor, and steps 5a and 5b which project toward the inside of the reaction frame 5 are formed at the upper and lower sides, respectively, of the reaction frame 5.

The illumination optical system IL is supported by a support column 7 fixed to the top surface of the reaction frame 5. For example, bright lines (g, h, i-lines) of an ultraviolet area emitted from a mercury lamp, far (or deep) ultraviolet light (DUV light) such as KrF excimer laser light (wavelength 248 nm) or the like, vacuum ultraviolet light (VUV light) such as ArF excimer laser light (wavelength 193 nm), F₂ laser light (wavelength 157 nm), or the like can be used for exposure light EL emitted from the illumination optical system IL.

The mask holding plate 3 of the stage device 1 is substantially horizontally supported at each comer by the step 5a of the reaction frame 5 via a control vibration unit 8, and an aperture 3a through which a pattern image of the mask M passes is provided at the center of the mask holding plate 3. The mask stage MST is arranged above the mask holding plate 3. At the center of the mask stage MST, an aperture K is provided which is in communication with the aperture 3a of the mask holding plate 3 and through which a pattern image of the mask M passes. On the bottom surface of the mask stage MST, a plurality of air bearings 9 are arranged which are non-contact bearings. The mask stage MST is floatingly supported by the air bearings 9 via a specified clearance with respect to the mask holding plate 3.

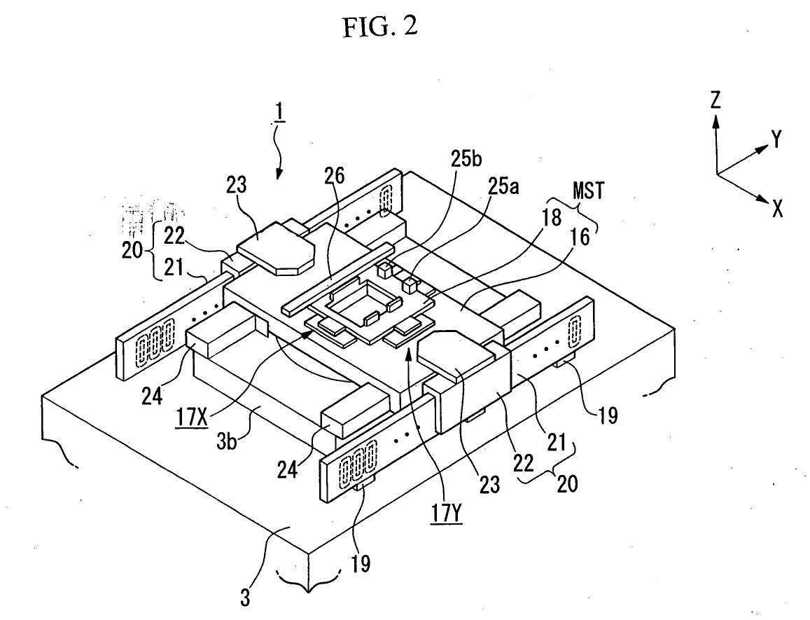

FIG. 2 is a schematic perspective view of the stage system 1 having the mask stage MST.

As shown in FIG. 2, the stage system 1 (mask stage MST) is provided with a mask coarse-moving stage 16 arranged on the mask holding plate 3, a mask micro-moving stage 18 arranged on the mask coarse-moving stage 16, a pair of Y linear motors 20, which can move the coarse-moving stage 16 on the mask holding plate 3 with a specified stroke in the Y axis direction, a pair of Y guides 24, which guide the coarse-moving stage 16 in the Y axis direction, and a pair of X voice coil motors 17X and a pair of Y voice coil motors 17Y which can micro-move the micro-moving stage 18 on the coarse-moving stage 16 in the X axis, Y axis, and θZ directions. Furthermore, in FIG. 1, the coarse-moving stage 16 and the micro-moving stage 18 are simplified and shown as one stage.

The respective Y linear motors 20 are provided with a pair of stators 21 formed of coil units (armature units) which are arranged so as to extend in the Y axis direction on the mask holding plate 3, and movable parts 22 which are arranged corresponding to these stators 21 and formed of magnetic units fixed to the coarse-moving stage 16 via coupling members 23. These moving magnet type linear motors 20 are constituted by the stators 21 and the movable parts 22, and as the movable parts 22 are driven by an electromagnetic mutual reaction between the stators 21, the coarse-moving stage 16 (mask stage MST) moves in the Y axis direction. The respective stators 21 are floatingly supported by the plurality of air bearings 19 which are non-contact bearings with respect to the mask holding plate 3. Because of this, according to the law of conservation of momentum, the stators 21 move in a −Y direction according to the movement in a +Y direction of the coarse moving stage 16. Thus, a reaction force generated during the movement of the coarse-moving stage 16 can be canceled by the movement of the stators 21. In addition, changes in a position of the center of gravity of the overall system can be prevented. As an alternative, the stators 21 can be arranged on (i.e., attached to) the reaction frame 5 instead of the mask holding plate 3. When the stators 21 are attached to the reaction frame 5, air bearings 19 are omitted, the stators 21 are fixed to the reaction frame 5, and a reaction force which acts on the stators 21 due to the movement of the coarse-moving stage 16 can be transmitted to a floor via the reaction frame 5.

The respective Y guides 24 guide the coarse-moving stage 16 moving in the Y axis direction and are fixed on the top surface of the upper protruding portion 3b formed at the center of the mask holding plate 3 so as to extend in the Y axis direction. Furthermore, between the coarse-moving stage 16 and the Y guides 24, an air bearing (not shown) which is a non-contact bearing is arranged, and the coarse-moving stage 16 is supported in a non-contact manner with respect to the Y guides 24.

The micro moving stage 18 adsorbs and holds the mask M via a vacuum chuck (not shown). A pair of Y moving mirrors 25a, 25b formed of corner cubes are fixed to the end portion in the +Y direction of the micro-moving stage 18. An X moving mirror 26 formed of a flat mirror extended in the Y axis direction is fixed to the end portion in the −X direction of the micro-moving stage 18. Additionally, as three laser interferometers (not shown) irradiating a measurement beam with respect to these moving mirrors 25a, 25b, 26 measure the distance between the respective moving mirrors, the position in the X axis, Y axis, and θZ directions of the mask stage MST can be detected with high accuracy. Based on the detecting result of the laser interferometers, the control device (CONT) drives each motor including the Y linear motors 20, the X voice coil motors 17X, and the Y voice coil motors 17Y, and performs positioning control of the mask M (mask stage MST) which is supported by the micro-moving stage 18.

In FIG. 1, a pattern image of the mask M passes through the apertures K and 3a and enters the projection optical system PL. The projection optical system PL is constituted by a plurality of optical elements, and these optical elements are supported by a lens barrel. The projection optical system PL is a reduction system having a zoom factor of, for example, ¼ or ⅕. Additionally, a unity magnification system or an enlargement system can be used for the projection optical system PL. In the outer circumference of the lens barrel of the projection optical system PL, a flange 10 is arranged which is integrated to this lens barrel. Furthermore, in the projection optical system PL, the flange 10 is engaged to a lens barrel holding plate 12 which is substantially horizontally supported by the step 5b of the reaction frame 5 via a vibration control unit 11.

The stage device 2 is provided with the substrate stage (movable part) PST, the substrate holding plate 4 which movably supports the substrate stage PST in a two-dimensional direction along an XY plane, an X guide stage 35 which movably supports and guides the substrate stage PST in the X axis direction, an X linear motor 40 which is arranged in the X guide stage 35 and can move the substrate stage PST in the X axis direction, and a pair of Y linear motors 30, which can move the X guide stage 35 in the Y axis direction. The substrate stage PST has a substrate holder PH which vacuum-adsorbs and holds the photosensitive substrate P, and the photosensitive substrate P is supported by the substrate stage PST via the substrate holder PH. Furthermore, on the bottom surface of the substrate stage PST, a plurality of air bearings 37 are arranged which are non-contact bearings, and the substrate stage PST is supported by these air bearings 37 in a non-contact manner with respect to the substrate holding plate 4. Furthermore, the substrate holding plate 4 is substantially horizontally supported above the base plate 6 via the vibration control unit 13.

On the +X side of the X guide stage 35, the movable part 34a of an X trim motor 34 is mounted. Furthermore, the stator 34b of the X trim motor 34 is arranged on the reaction frame 5. Because of this, a reaction force when the substrate stage PST is driven in the X axis direction is transmitted to the base plate 6 via the X trim motor 34 and to the reaction frame 5.

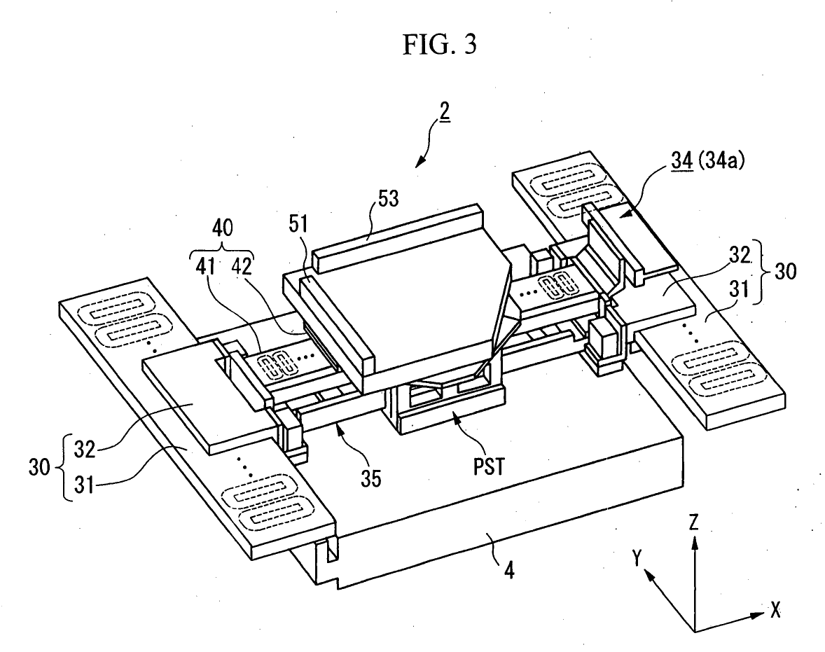

FIG. 3 is a schematic perspective view of the stage device 2 having the substrate stage PST.

As shown in FIG. 3, the stage device 2 is provided with an X guide stage 35 having its longest dimension in the X axis direction, an X linear motor 40 which can move the substrate stage PST with a specified stroke in the X axis direction, and a pair of Y linear motors 30, which can move the X guide stage 35 in the Y axis direction along with the substrate stage PST.

The X linear motor 40 is provided with a stator 41 formed of a coil unit which is arranged in the X guide stage 35 so as to extend in the X axis direction, and a movable part 42 which is arranged corresponding to the stator 41 and formed of a magnetic unit fixed to the substrate stage PST. This moving magnet type linear motor 40 is constituted by the stator 41 and the movable part 42. As the movable part 42 is driven by an electromagnetic mutual reaction between the movable part 42 and the stator 41, the substrate stage PST moves in the X axis direction. Here, the substrate stage PST is supported in a non-contact manner by a magnetic guide formed of an actuator and a magnet which maintains a specified gap in the Y axis direction with respect to the X guide stage 35. In the alternative, an air bearing can be used instead of the magnetic guide in order to support the substrate stage PST in a non-contact manner. The substrate stage PST moves in the X axis direction by the X linear motor 40 in a state in which it is supported in a non-contact manner by the X guide stage 35.

The respective Y linear motors 30 are provided with movable parts 32 formed of magnetic units arranged on both ends in a longitudinal direction of the X guide stage 35 and stators 31 formed of coil units arranged corresponding to the movable parts 32. Here, the stators 31 are arranged on supports 36 (see FIG. 1) protruding from the base plate 6. Furthermore, the stators 31 and the movable parts 32 are simplified as shown in FIG. 1. These moving magnet type linear motors 30 are constituted by the stators 31 and the movable parts 32, and as the movable parts 32 are driven by an electromagnetic mutual reaction with the stators 31, the X guide stage 35 moves in the Y axis direction. Furthermore, by adjusting the respective drives of the Y linear motors 30, the X guide stage 35 is rotatably moved in the θZ direction. Therefore, the substrate stage PST can be moved by the Y linear motors 30 in the Y axis direction and in the θZ direction substantially integrated to the X guide stage 35.

In FIG. 1, on a side edge of the −X side of the substrate stage PST, an X moving mirror 51 is arranged which extends in the Y axis direction, and a laser interferometer 50 is arranged at a position facing the X moving mirror 51. The laser interferometer 50 irradiates laser beams (detection light) toward a reflective surface of the X moving mirror 51 and a reference mirror 52 arranged under the lens barrel of the projection optical system PL. At the same time, based on the interference of the reflected light and the emitted light, by measuring the relative displacement of the X moving mirror 51 and the reference mirror 52, a position in the X axis direction of the substrate stage PST and the photosensitive substrate P is detected in real time with a specified resolution. In the same manner, on a side edge of the +Y side of the substrate stage PST, a Y moving mirror 53 (not shown in FIG. 1, see FIG. 3) is arranged which extends in the X axis direction, and a Y laser interferometer (not shown) is arranged at a position facing the Y moving mirror 53. The Y laser interferometer irradiates laser beams toward the reflective surface of the Y moving mirror 53 and the reference mirror (not shown) under the lens barrel of the projection optical system PL. At the same time, based on the interference of the reflected light and the emitted light, by measuring the relative displacement of the Y moving mirror and the reference mirror, the position in the Y axis direction of the substrate stage PST and the photosensitive substrate P is detected in real time with a specified resolution. The detected result of the laser interferometer is output to the control device (CONT), and based on the detected result of the laser interferometer, the control device (CONT) performs positioning control of the substrate stage PST via the linear motors 30, 40.

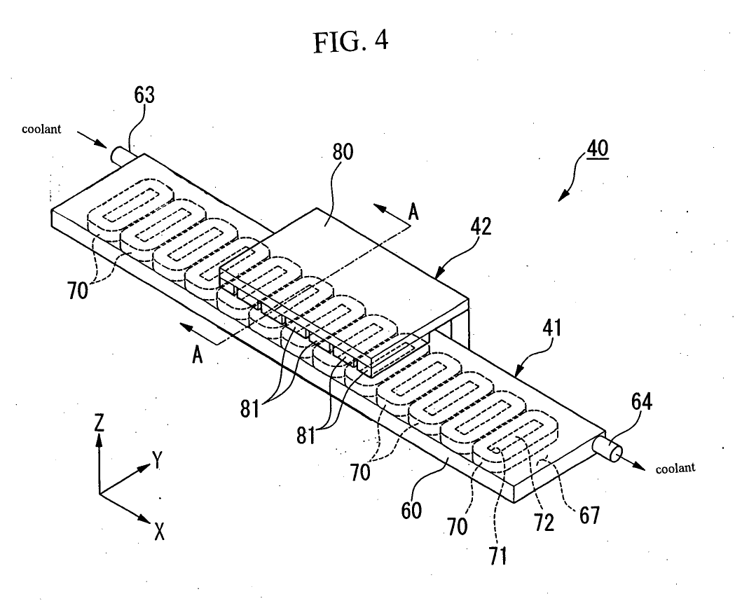

The following explains a first embodiment of linear motors 40 (20, 30) and a cooling system of this invention with reference to FIGS. 4-6. In the following description, the X linear motor 40 arranged in the substrate stage PST is explained, but the linear motors 20 arranged in the Y linear motor 30 and the mask stage MST can have substantially the same structure.

FIG. 4 is a schematic perspective view of the linear motor (linear motor device) 40.

As shown in FIG. 4, the linear motor 40 is provided with a stator 41 formed of coil units having the X axis direction (specified direction) as a longitudinal direction thereof, and a movable part 42 formed of magnetic units. The stator 41 has a housing 60 having an internal space 67 and coils 70 arranged in the internal space 67. The coils 70 have central hollow parts 71, and in the central hollow parts 71, supports 72 supporting the coils 70 are arranged. The supports 72 supporting the coils 70 are fixed to the housing 60 by screws (not shown), for example, as fixing members. A plurality of coils 70 are arranged in the X axis direction (specified direction). A driving electric current in which an electric current amount has been controlled by the control device (CONT) flows into the coils 70. Meanwhile, the movable part 42 has a plurality of magnets 81 and is provided with a yoke 80 which is arranged sandwiching the housing 60 of the stator 41. The respective plurality of magnets 81 are permanent magnets and are aligned and mounted in the yoke 80 in a specified direction (X axis direction), and magnets with different magnetic poles are alternatingly aligned. Furthermore, the magnets 81 sandwich the housing 60 (stator 41), and different magnetic poles face each other.

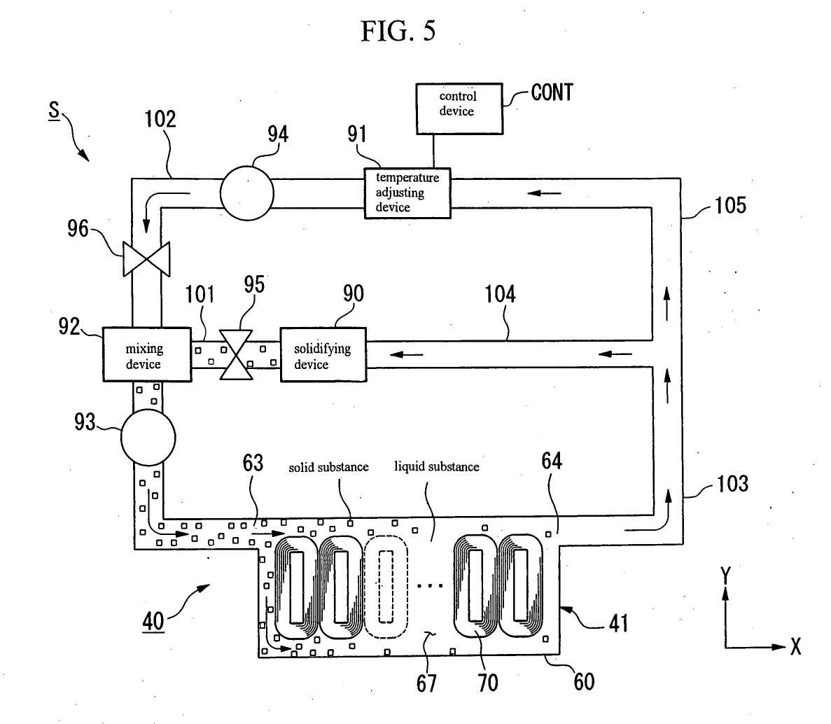

FIG. 5 is a schematic structural diagram of the cooling system S which cools the coils 70 of the stator 41. In FIG. 5, the linear motor device 40 is provided with a cooling system S which cools the coils 70 by supplying a coolant to an internal space 67 where the coils 70 are arranged. The housing 60 is provided with an entrance 63 which communicates with the internal space 67 of the housing 60 and through which coolant enters this internal space 67, and an exit 64 which communicates with the internal space 67 and through which the coolant within the internal space 67 exits to outside. The entrance 63 is arranged on one end portion of the longitudinal direction (X axis direction, specified direction) of the housing 60, and the exit 64 is arranged on other end portion of the longitudinal direction of the housing 60. Furthermore, the cooling system S supplies a coolant for the internal space 67 via the entrance 63. After the coolant supplied to the internal space 67 via the entrance 63 flows into the internal space 67, it exits from the exit 64.

The coolant supplied to the internal space 67 from the cooling system S contains a cooling substance formed of two or more different substances selected from among solid, liquid, and gas. In this embodiment, the coolant is constituted by a liquid formed of a cooling substance and a solid formed of a cooling substance dispersed within the liquid. Here, in the following description, a liquid formed of a cooling substance is “liquid substance,” and a solid formed of a cooling substance is “solid substance”. An inactive (e.g., inert) substance is suitable for a cooling substance. For example, hydrofluoroether (e.g., “Novec HFE”: manufactured by 3M, Minneapolis, Minn.), a fluoride system inactive liquid (e.g., “Flourinert” manufactured by 3M, Minneapolis, Minn.), or the like, can be used or water also can be used as a cooling substance. When water is used as a cooling substance, a coolant is constituted by water (liquid substance) and ice (solid substance) dispersed in this water. Furthermore, substances other than water and ice as a cooling substance also can be mixed into a coolant. Additionally, particle-shaped (i.e., crushed) ice (solid substance) also can be dispersed into water (liquid substance) as a coolant, or it can be in a sherbet-like state. The mixture or solution can be a slurry as well. On the surface of the coils 70, surface treatment is performed so that conductive lines themselves do not contact the coolant.

The cooling system S is provided with a solidifying device 90 which generates a solid substance (e.g., ice) to be included in the coolant, a temperature adjusting device 91 which adjusts the temperature of a liquid substance (e.g., water) to be included in the coolant, a mixing device 92 which mixes the solid substance generated in the solidifying device 90 with the liquid substance whose temperature has been adjusted in the temperature adjusting device 91, and a pump (supply device) 93 which supplies a coolant (mixed substance (mixture) of liquid and solid substances) generated in the mixing device 92 to the internal space 67 of the housing 60. The solid substance generated in the solidifying device 90 is supplied to the mixing device 92 via a route 101, and the liquid substance whose temperature has been adjusted in the temperature adjusting device 91 is supplied to the mixing device 92 by the driving of the pump 94 via a route 102. The temperature adjusting device 91 is controlled by the control device (CONT), and the control device (CONT) adjusts the temperature of the liquid substance supplied to the mixing device 92 (that is, the internal space 67) by the temperature adjusting device 91. Furthermore, a valve 95 is arranged in the route 101, and a valve 96 is arranged in the route 102. The operations of the valves 95, 96 are controlled by the control device (CONT). The control device (CONT) adjusts the amount (amount supplied per hour) of the solid substance supplied to the mixing device 92 from the solidifying device 90 by the valve 95 and can adjust the amount (supplied amount per hour) of the liquid substance supplied to the mixing device 92 from the temperature adjusting device 91 through the valve 96. Furthermore, by cooling the liquid substance to a solidifying point or less, the solidifying device 90 converts this liquid substance to a solid substance. In addition, after converting a liquid substance to a solid substance, the solidifying device 90 supplies this solid substance to the mixing device 92 after grinding the solid substance to particles. Furthermore, in this embodiment, the mixing device 92 generates a coolant by agitating the solid substance with the liquid substance, and the pump 93 as a supply device supplies the generated coolant to the internal space 67. However, for example, the mixing device 92 may be constituted by an injection device, and mixing and supply can be performed by the action of the moving fluid.

The following explains a method of cooling the linear motor 40 by using the above mentioned cooling system S.

When a driving electric current is supplied from the control device (CONT) to the coils 70 and heat is generated in the coils 70, the cooling system S supplies a coolant to the internal space 67 of the housing 60 in which the coils 70 are arranged. In the cooling system S, a specified amount of solid substance is supplied from the solidifying device 90 to the mixing device 92. At the same time, a specified amount of liquid substance is supplied from the temperature adjusting device 91. Here, the control device (CONT) adjusts the valves 95, 96 and adjusts the respective amounts of solid and liquid substances to be supplied to the mixing device 92. By so doing, the control device (CONT) sets a mixing ratio of the solid and liquid substances mixed in the mixing device 92.

The mixing device 92 mixes the supplied solid and liquid substances at a specified mixing ratio and generates a coolant. The generated coolant is supplied by the pump 93 via the entrance 63 to the internal space 67 of the housing 60 in which the coils 70 are arranged. The coolant supplied to the internal space 67 flows along a direction (X axis direction, specified direction) in which the plurality of coils 70 are aligned, while absorbing the heat of the coils 70. Here, the solid substance included in the coolant is gradually melted (i.e., its state changes from solid to liquid) by absorbing the heat of the coils 70. At this time, the solid substance contained in the coolant absorbs the heat of the coils 70 when it is changed from a solid state to a liquid state. That is, the coolant absorbs the heat of the coils 70 as it changes from a solid state to a liquid state and cools the coils 70. The coils 70 are cooled due to the absorption of heat that occurs due to the change in the state of the cooling substance. Therefore, the temperature of the coolant does not increase while cooling the coils 70.

The coolant which absorbs the heat of the coils 70 and flows within the internal space 67 toward the exit 64 eventually exits outside the housing 60 from the exit 64. Here, the amount of the solid substance contained in the coolant which is exited from the exit 64 is less than the amount of the solid substance which enters the entrance 63. This is because the solid substance is melted by absorbing the heat of the coils 70 as it flows through the internal space 67. After the coolant from the exit 64 flows into a route 103, it is separated into routes 104 and 105. Here, within the coolant which flows into the route 103 (routes 104, 105), the majority is occupied by a liquid substance and there is only a small amount of solid substance. Among the branched coolant, the coolant which flows into the route 104 is supplied to the solidifying device 90. The solidifying device 90 converts a liquid substance to a solid substance by cooling the cooling substance whose majority is a liquid substance. The cooling substance (solid substance) solidified by the solidifying device 90 is re-supplied to the mixing device 92 and is re-used. Meanwhile, the coolant (liquid substance) which flows into the route 105 is supplied to the temperature adjusting device 91 and its temperature is adjusted. The cooling substance (liquid substance) whose temperature has been adjusted by the temperature adjusting device 91 is re-supplied to the mixing device 92 and is re-used. Thus, the cooling substance (coolant) is circulated in the routes including the mixing device 92, the internal space 67 of the housing 60, the solidifying device 90, and the temperature adjusting device 91.

The cooling system S of this embodiment of the invention has a structure which cools the coils 70 without increasing the temperature of a coolant by using latent heat based on changes in a state of a cooling substance. Therefore, at least part of the solid substance included in the coolant supplied to the internal space 67 from the entrance 63 should remain in the coolant that exits from the exit 64. Meanwhile, flowability of the coolant deteriorates if too much solid substance exists in the coolant. Therefore, it is preferable that the amount of the solid substance included in the coolant supplied to the internal space 67 should be set at a minimum within a range where the coils 70 can be cooled with latent heat of the state change. Because of this, the mixing device 92 supplies the cooling substance after setting a mixing ratio of the solid substance and the liquid substance within the coolant to be supplied to the internal space 67 at an optimum value in advance.

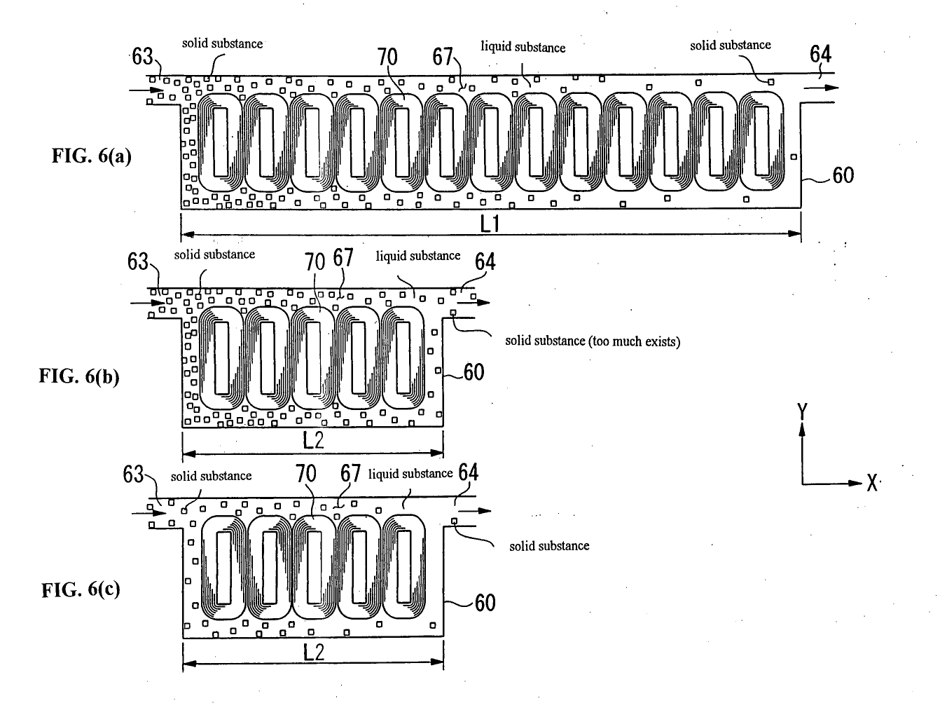

As shown in a diagram of FIG. 6(a), when the coils 70 within the housing 60 in which a distance between the entrance 63 and the exit 64 in the X axis direction (specified direction) is L1 are cooled, the mixing device 92 sets a mixing ratio of solid and liquid substances within the coolant at a minimum amount at which the respective plurality of coils 70 aligned in the X axis direction can be cooled by latent heat of the state change. In this case, a slight amount of solid substance exists within the coolant at the vicinity of the exit 64. Meanwhile, assuming that each coil in FIG. 6(b) generates the same amount of heat as each coil in FIG. 6(a) (and thus, less total heat is generated by the FIG. 6(b) system than by the FIG. 6(a) system), i.e., the amount of heat generated per unit length in FIGS. 6(a) and 6(b) is the same, as shown in FIG. 6(b), when the coils 70 within the housing 60 in which the distance between the entrance 63 and the exit 64 is L2 (shorter than L1) are cooled, if the coolant having the mixing ratio in FIG. 6(a) is supplied to the internal space 67, there is an excess amount of solid substance, a large amount of solid substance exists in the vicinity of the exit 64, and flowability of the coolant in the internal space 67 deteriorates. Therefore, in this situation, when the distance between the entrance 63 and the exit 64 is L2, by setting a less amount of solid substance for the liquid substance within the coolant to be supplied to the internal space 67 via the entrance 63, as shown in FIG. 6(c), suitable flowability of the coolant is maintained.

In the same manner, by setting the mixing ratio of solid and liquid substances according to the heat amount of the coils 70, the coolant can give a desired cooling effect while maintaining suitable flowability. Specifically, when the heat amount of the coils 70 is large, a large amount of the solid substance can be set with respect to the liquid substance at the time of supplying to the internal space 67, and when the heat amount of the coils 70 is small, a small amount of the solid substance can be set with respect to the liquid substance.

As explained above, the linear motor 40 has a structure which is cooled by latent heat according to changes in a state of a cooling substance, so it can be cooled without increasing the temperature of the cooling substance. Therefore, a temperature distribution from the entrance 63 to the exit 64 is not generated, so the deterioration of measurement accuracy of an optical interference measuring instrument due to the generation of air fluctuation within the device, and generation of thermal deformation (e.g., due to heat expansion) of a member or the like in the vicinity of the exit 64 can be controlled. Thus, high stage positioning accuracy can be accomplished, and exposure processing with good accuracy can be performed.

Furthermore, in this embodiment, the temperature of the liquid substance to be supplied to the mixing device 92 is adjusted by the temperature adjusting device 91, and then the substance is supplied. However, the temperature adjusting device 91 adjusts the temperature of the liquid substance to be supplied to the mixing device 92 to a degree such that, when the solid substance mixed in the mixing device 92 is supplied to the internal space 67 without being melted and moves through the internal space 67, a small amount of the solid substance exists (i.e., remains) in the coolant in the vicinity of the exit 64. Furthermore, the type (the temperature at which the cooling substance changes from a solid phase to a liquid phase) of the cooling substance which cools the linear motor 40 is selected according to the target cooling temperature of the coils 70.

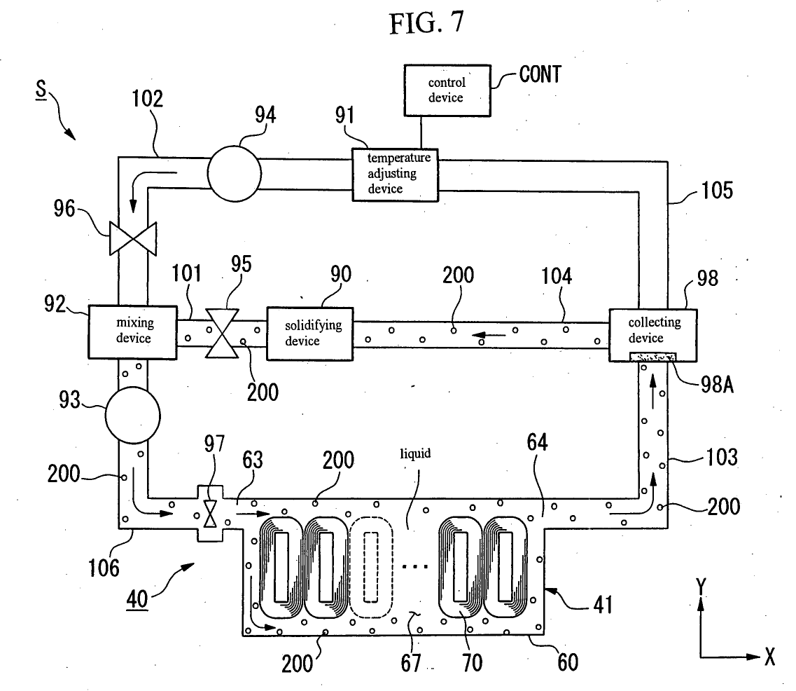

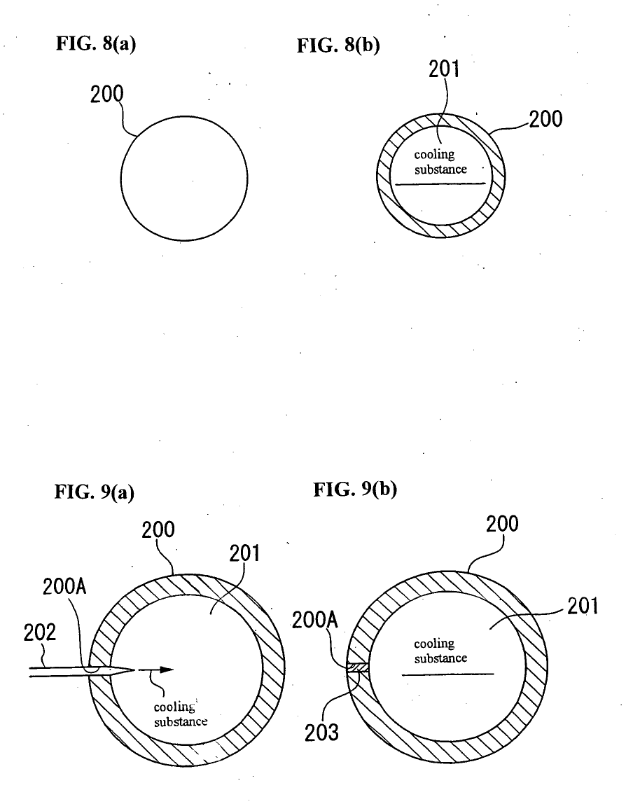

The following explains a second embodiment of the cooling system and the linear motor device of this invention with reference to FIGS. 7 and 8. Here, the same symbols are used for the same or equivalent structural parts as in the above-mentioned first embodiment, and the explanation of such parts is simplified or omitted.

In FIG. 7, in the cooling system S, particle-shaped holding members 200 filled with a cooling substance cool the coils 70 of the linear motor 40 by using a coolant dispersed in a specified liquid. The cooling system S is provided with a temperature adjusting device 91 which adjusts the temperature of the liquid to be supplied to the internal space 67 of the housing 60 of the linear motor 40, a solidifying device 90 which solidifies a cooling substance held in the holding members 200, a mixing device 92 which mixes a liquid whose temperature has been adjusted in the temperature adjusting device 91 with the holding members 200 holding a cooling substance solidified by the solidifying device 90, and a pump 93 as a supply device which supplies a coolant generated in the mixing device 92 to the internal space 67 of the housing 60. The pump 93 supplies a coolant to the internal space 67 via the route 106 and the entrance 63. Additionally, in the middle of the route 106, an agitating device 97 is arranged which agitates a coolant to be supplied to the internal space 67 by the pump 93. By so doing, even if the relative densities of the liquid and the holding members 200 are different, the holding members 200 are uniformly dispersed in a liquid by being agitated by the agitating device 97 and are supplied to the internal space 67. Furthermore, the agitating device 97 can be arranged at any arbitrary position between the mixing device 92 and the housing 60, or a structure can also be used in which the agitating device 97 is arranged in the vicinity of the entrance 63 of the internal space 67 of the housing 60.

The coolant which passed through the internal space 67 of the housing 60 can leave the housing 60 from the exit 64. In the middle of the route 103 connected to the exit 64, a collecting device 98 is arranged which collects the holding members 200 included in the coolant. The collecting device 98 is provided with a filter 98A which can collect the holding members 200, and thus the holding members 200 in the coolant from the exit 64 are collected by the filter 98A.

FIGS. 8(a) and 8(b) are diagrams showing a first embodiment of the holding members 200. FIG. 8(a) is an outer view, and FIG. 8(b) is a cross-sectional view of FIG. 8(a). As shown in FIGS. 8(a) and 8(b), each holding member 200 is a capsule-shaped member, and is a spherical member having a hollow part 201. The holding members 200 have an outer diameter of, for example, approximately several mm to several μm. Additionally, a cooling substance whose phase can be changed to solid, liquid or gas phases is arranged in the hollow part 201. Here, as a cooling substance, in the same manner as in the first embodiment, hydrofluoroether, fluoride group inert liquid, or the like can be used, or water can be used for a cooling substance. Additionally, a cooling substance arranged in the hollow part 201 can also be a gel cooling substance which is made to be a gel by a specified gel agent. Furthermore, when a cooling substance held in the hollow 201 is supplied to the internal space 67 of the housing 60 in a state in which it is held in the holding member 200, a certain amount of heat is absorbed by latent heat according to a phase change.

Meanwhile, in this embodiment, the liquid in which the holding member 200 is dispersed is constituted by a material which is different from a cooling substance held in the holding member 200. For example, when a cooling substance held in the holding member 200 is water (ice), the liquid can be hydrofluoroether. By so doing, the temperature at which the phase of the cooling substance changes (e.g., from solid to liquid) can be set at a different value than the temperature at which the liquid in which the holding members are dispersed changes between solid and liquid phases. Thus, the cooling operation of the coils 70 can be performed without increasing the temperature of the liquid by selecting the type of the cooling substance according to the target cooling temperature of the coils 70. Alternatively, the same material can be used for a cooling substance held in the holding member 200 and the liquid in which the holding members 200 are dispersed.

The gel could undergo a phase change by changing between its solid phase (frozen form) and its liquid phase (more precisely, an unfrozen form). Alternatively, or in addition, the gel can remain in its unfrozen gel form and have a material dispersed in it (for example, particles of ice/water) that changes phase, for example, between a solid and a liquid. Furthermore, the gel need not change phase, but instead could be made from a material that has a high heat capacity compared to the liquid material in which the holding members 200 are dispersed. As is known, a substance's heat capacity is the amount of heat a given amount of that substance can absorb so as to produce a predetermined amount of temperature increase (e.g., 1 degree Celsius) in the substance. For example, a first substance that increases in temperature by 1° C. when it absorbs 10 watts of heat energy has a higher heat capacity than a second substance that increases in temperature by 1° C. when it absorbs 2 watts of heat energy. Thus, for example, if the holding members are mixed in water, the gel contained in the holding members would have a heat capacity that is higher than the heat capacity of the water. In this situation, the gel would absorb most of the heat generated by the motor coils, while the coolant temperature (i.e., the temperature of the water and the holding members dispersed therein) would increase by an amount that is much less than what would occur if water alone were used. Thus, while the coolant temperature would increase between the entrance 63 and the exit 64 of the housing 60 more than in the embodiments in which the holding members contain a substance that changes phase (and thus do not increase in temperature), the use a gel having a higher heat capacity than the liquid in which the holding members are dispersed still is an improvement over the conventional use of a liquid with no heat-absorbing mechanism (either solid-phase particles of the cooling substance or higher-heat-capacity gel) therein. Of course, if the above-described gel is used (i.e., that does not change phase), the solidifying device 90 would not actually cause the gel to solidify, but rather would merely cool (i.e., remove heat from) the gel so as to reduce the temperature of the gel.

The holding members 200 are formed by, for example, ceramics, or the holding members 200 can be constituted by a magnetic body such as metal or the like, and also can be a polymer. It is preferable that the holding members 200 holding a cooling substance should have substantially the same relative density as the liquid mixed in the mixing device 92. For example, when the relative density of the cooling substance held by the holding members 200 is larger than the relative density of the liquid, the material of the holding members 200 is selected to be a material whose density is smaller than the relative density of the liquid. By so doing, the holding members 200 holding a cooling substance can be uniformly dispersed in the liquid.

Furthermore, when the holding members 200 are formed of a magnetic body such as metal or the like, by arranging a magnetic force generating device in the collecting device 98, the collecting device 98 can collect the holding members 200 by a magnetic force of the magnetic force generating device.

The following explains a method of cooling the coils 70 by using a coolant in which the holding members 200 having the above-mentioned structure are dispersed in the liquid.

When a driving electric current is supplied to the coils 70 by the control of the control device (CONT) and heat is generated in the coils 70, the cooling system S supplies a coolant to the internal space 67 of the housing 60 in which the coils 70 are arranged. In the cooling system S, a specified amount of particle-shaped holding members 200 filled with the cooling substance (solid substance) solidified by the solidifying device 90 is supplied to the mixing device 92, and the liquid whose temperature has been adjusted by the temperature adjusting device 91 is supplied. Here, the control device (CONT) adjusts the valves 95, 96, and the respective amounts of the holding members 200 to be supplied to the mixing device 92 and the liquid are adjusted. By so doing, the control device (CONT) sets a mixing ratio of the holding members 200 and the liquid to be mixed in the mixing device 92.

The mixing device 92 mixes the supplied holding members 200 and liquid at a predetermined mixing ratio and generates a coolant. The generated coolant is supplied by the pump 93 via the entrance 63 to the internal space 67 of the housing 60 in which the coils 70 are arranged. The coolant supplied to the internal space 67 flows along a direction (X axis direction, specified direction) in which the plurality of coils 70 are aligned while absorbing the heat of the coils 70. Here, the solid substance filled in the holding member 200 included in the coolant is gradually melted by absorbing the heat of the coils 70 via the holding member 200. At this time, the solid substance held in the holding member 200 absorbs the heat of the coils 70 when it changes from a solid state to a liquid state. That is, the coolant absorbs the heat of the coils 70 due to a change of a state of a cooling substance from a solid state to a liquid state and cools the coils 70. The coils 70 are cooled by absorbed heat due to a change in a state of the cooling substance, i.e., latent heat when a state of the cooling substance changes. Therefore, while cooling the coils 70, the temperature of the coolant does not increase. Alternatively, when a gel that has a relatively high heat capacity but that does not change phase is used, the temperature at the exit 64 may be higher than at the entrance 63, but this temperature differential will be much less than what would occur if a liquid alone was used as the coolant.

The coolant which absorbs the heat of the coils 70 and flows through the internal space 67 toward the exit 64 ultimately leaves the housing 60 from the exit 64. Here, by flowing through the internal space 67 and absorbing the heat of the coils 70, the cooling substance held in the holding members 200 in the coolant exiting from the exit 64 is converted from a solid substance to a liquid substance. The coolant from the exit 64 flows into the collecting device 98 via the route 103. The collecting device 98 collects the holding members 200 included in the coolant. The holding members 200 collected in the collecting device 98 are supplied to the solidifying device 90 via the route 104. The solidifying device 90 solidifies a liquid substance held in the holding members 200 by converting this into a solid substance. The holding members 200 filled with the solid substance solidified by the solidifying device 90 are re-supplied to the mixing device 92 and are re-used. Meanwhile, in the coolant which flows into the route 103, the liquid which went through the collecting device 98 is supplied to the temperature adjusting device 91 via the route 105, and the temperature is adjusted. The liquid whose temperature has been adjusted by the temperature adjusting device 91 is re-supplied to the mixing device 92 and is re-used.

Furthermore, in the second embodiment as well, at least part of the cooling substance (solid substance) which is held in the respective plurality of holding members 200 to be supplied to the internal space 67 from the entrance 63 needs to maintain a solid state without being melted until after it leaves the exit 64. Because of this, the mixing device 92 sets a mixing ratio of the holding members 200 and the liquid within the coolant to be supplied to the internal space 67 at an optimal value in advance. Furthermore, the mixing device 92 sets a mixing ratio of the holding members 200 and the liquid according to the heat amount of the coils 70.

FIGS. 9(a) and 9(b) are diagrams showing one example of a process of manufacturing the holding members 200. As shown in FIG. 9(a), an injection needle shaped injecting device 202 is inserted to the hollow part 201 of the holding members 200 via a hole 200A. Furthermore, a cooling substance is injected to the hollow part 201 from the injecting device 202. At this time, when the cooling substance is a gel substance, an injecting operation can be smoothly operated. Additionally, if a cooling substance is injected to the hollow part 201, the hole 200A of the holding members 200 in which the injecting device 202 is arranged is sealed by a sealing member 203. In this case as well, as the cooling substance is constituted by a gel substance, it is difficult for the cooling substance within the hollow part 201 to leak outside via the hole 200A, so operability can be improved when the sealing member 203 is arranged in the hole 200A.

Furthermore, the process of manufacturing the holding members 200 as shown in FIGS. 9(a) and 9(b) is an example, and the holding members 200 can also be manufactured by other manufacturing methods. For example, the holding members 200 for holding a cooling substance can be manufactured by inserting and/or arranging a cooling substance in the concave regions of two or more hemi-spherical members and then attaching the hemi-spherical members together.

An internal pressure of the holding members 200 can be arbitrarily set. For example, according to the method shown in FIGS. 9(a) and 9(b), by adjusting the amount of a cooling substance to be supplied to the hollow part 201, the internal pressure of the holding members 200 can be arbitrarily set, or using the injecting device 202 shown in FIG. 9(a), by injecting a specified amount of a specified fluid (e.g., air) to the hollow part 201 of the holding member 200 as well, the internal pressure of the holding member 200 can be adjusted. Additionally, by adjusting the pressure of the hollow part 201 of the holding part 200, the temperature (phase change temperature) can be adjusted in which a cooling substance held in the hollow part 201 of the holding member 200 changes from a solid state to a liquid state. That is, based on the target change temperature of the cooling substance, the internal pressure of the holding members 200 can be set, and the coils 70 can be cooled to an arbitrary temperature by adjusting the internal pressure.

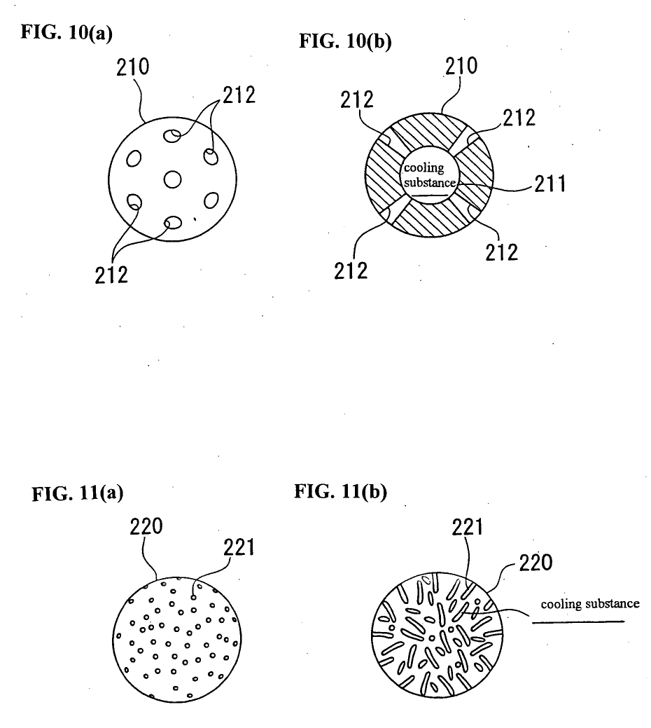

FIGS. 10(a) and 10(b) are diagrams showing a second embodiment of the holding members. FIG. 10(a) is an outer view, and FIG. 10(b) is a cross-sectional view of FIG. 10(a). The holding member 210 shown in FIGS. 10(a) and 10(b) is a particle-sized member, for example, for holding a cooling substance which absorbs an amount of heat due to a phase change between at least two phases of solid, liquid, and gas phases (or a gel having a high heat capacity), and has an internal space 211 for holding the cooling substance and a plurality of through holes 212 that are in communication with an outside of the internal space 211. In FIGS. 10(a) and 10(b), the internal space 211 is a hollow part which is formed inside the holding member 210, and the cooling substance is held in this hollow part (internal space) 211. Furthermore, in the same manner as the holding member 200 as shown in FIGS. 8(a) and 8(b), the holding member 210 solidifies the held cooling substance in the solidifying device 90 and is then supplied to the mixing device 92. The mixing device 92 mixes the holding member 210 from the solidifying device 90 with a liquid from the temperature adjusting device 91 and is supplied to the internal space 67 of the housing 60.

As described in the above-mentioned embodiment, hydrofluoroether, fluoride group inert liquid, or the like can be used as a cooling substance held in the holding member 210, or water can also be used as a cooling substance. Additionally, the solid cooling substance held in the hollow part 211 absorbs heat by phase change when it is supplied to the internal space 67 of the housing 60 in a state in which it is held in the holding member 210. Here, by making a cooling substance which is arranged in the hollow part 211 a gel substance, handling can be easy. The gel could absorb heat while changing phase and thus maintain a constant temperature, or it could absorb heat without changing phase but still minimize temperature increase of the coolant by having a heat capacity that is higher than the heat capacity of the coolant liquid in which the gel (held by holding members) is dispersed.

In this embodiment, it is preferable that the through holes 212 are appropriately sized so that the cooling substance is held in the holding members 210 by capillary action. The holding members 210 act like a wick, and surface tension firmly holds the cooling substance (e.g., water/ice), which is different from the liquid (e.g., hydrofluoroether) in which the holding members 210 are mixed, within the holding members 210. Alternatively, the liquid in which the holding members 210 are dispersed can be the same material as the cooling substance held in the holding members 210.

The holding member 210 is constituted by, for example, ceramics or a magnetic body formed of metal. By making the holding member 210 a magnetic body, and by arranging a magnetic force generating device in the collecting device 98, the holding member 210 can be collected by a magnetic force. Furthermore, it is preferable that the holding member 210 holding a cooling substance has substantially the same relative density as the liquid mixed in the mixing device 92. By so doing, the holding members 210 held in the cooling substance are uniformly dispersed in the liquid.

The following explains a method of cooling the coils 70 by using a coolant in which holding members 210 having the above-mentioned structure are dispersed in the liquid.

When a driving electric current is supplied to the coils 70 by the control of the control device (CONT) and the coils 70 generate the heat, the cooling system S supplies a coolant to the internal space 67 of the housing 60 in which the coils 70 are arranged. In the cooling system S, a specified amount of the particle-shaped holding members 210 which hold the solidified cooling substance (solid substance) in the hollow part 211 is supplied from the solidifying device 90 to the mixing device 92. At the same time, a specified amount of the liquid whose temperature has been adjusted is supplied from the temperature adjusting device 91. Here, the control device (CONT) adjusts the valves 95, 96 and the respective amounts of the holding members 210 and the liquid to be supplied to the mixing device 92 are adjusted. By so doing, the control device (CONT) sets a mixing ratio of the holding members 210 and the liquid mixed in the mixing device 92.

The mixing device 92 mixes the supplied holding members 210 with the liquid at a specified mixing ratio and generates a coolant. The generated coolant is supplied from the pump 93 via the entrance 63 to the internal space 67 of the housing 60 in which the coils 70 are arranged. The coolant supplied to the internal space 67 flows along a direction (X axis direction, specified direction) in which the plurality of coils 70 are aligned while absorbing the heat of the coils 70. Here, the solid substance held in the holding members 210 included in the coolant absorbs the heat of the coils 70 and is gradually melted. At this time, the solid substance held in the holding members 210 absorbs the heat of the coils 70 when it changes from a solid state to a liquid state. That is, the coolant absorbs the heat of the coils 70 due to the change of the state of a cooling substance from a solid state to a liquid state and cools the coils 70. The coils 70 are cooled by absorbed heat due to the change of the state of a cooling substance, that is, latent heat that is generated when the state of a cooling substance changes. Therefore, the temperature of the coolant does not increase while cooling the coils 70.

The coolant which absorbs the heat of the coils 70 and flows through the internal space 67 toward the exit 64 eventually exits from the exit 64 to outside the housing 60. The coolant from the exit 64 flows into the collecting device 98 via the route 103. The collecting device 98 collects the holding members 210 included in the coolant. The holding members 210 collected in the collecting device 98 are supplied to the solidifying device 90 via the route 104 along with part of the liquid. The solidifying device 90 solidifies a liquid (liquid substance) held in the hollow part 211 of the holding members 210 and converts the liquid (liquid substance) of the hollow part 211 into a solid substance. The holding part 210 which holds the solid substance solidified by the solidifying device 90 is re-supplied to the mixing device 92 and is re-used. Meanwhile, in the coolant which flows into the route 103, the liquid which went through the collecting device 98 is supplied to the temperature adjusting device 91 via the route 105, and the temperature is adjusted. The liquid whose temperature has been adjusted by the temperature adjusting device 91 is re-supplied to the mixing device 92 and is re-used.

FIGS. 11(a) and 11(b) are diagrams showing a third embodiment of a holding member. FIG. 11(a) is an outer view, and FIG. 11(b) is a cross-sectional view of FIG. 11(a). The holding members 220 shown in FIGS. 11(a) and 11(b) are formed of a porous body and hold a cooling substance within the porous body. That is, in the holding member 220 shown in FIGS. 11(a) and 11(b) some of the holes among a plurality of porous holes 221 form an internal space for holding a cooling substance. The holding member 220 is formed of a porous material (capable of absorbing liquid like a wick), e.g., sintered metal particles, sintered metal fibers, or the like. When the coils 70 are cooled by using the holding members 220 shown in FIGS. 11(a) and 11(b), in the same manner as in the holding members 210 shown in FIGS. 10(a) and 10(b), first, a cooling substance (liquid substance) which is held in the holding members 220 is solidified by the solidifying device 90. Furthermore, the mixing device 92 mixes holding members 220 which hold a solid substance generated in the solidifying device 90. The coolant generated in the mixing device 92 is supplied from the pump 93 to the internal space 67 of the housing 60. The solid substance which is held by the holding members 220 flowing into the internal space 67 of the housing 60 absorbs the heat of the coils 70 and is melted by absorbing the heat. The coolant exits out of the housing 60 from the exit 64 and flows into the route 103. In the coolant which flows into the route 103, after the holding members 220 are collected by the collecting device 98, they are transferred to the solidifying device 90 along with part of the liquid and then to the mixing device 92 and re-used. Meanwhile, after part of the remainder of the liquid which went through the collecting device 98 is transferred to the temperature adjusting device 91 and the temperature is adjusted, it is transferred to the mixing device 92 and re-used.

Furthermore, in the above-mentioned first and second embodiments, a structure is used in which the coils 70 are cooled by absorbing heat based on latent heat when a cooling substance changes from a solid phase to a liquid phase, but a structure can also be used in which the coils 70 are cooled based on latent heat when a cooling substance changes from a liquid phase to a gas phase.

One aspect of the invention is a coolant that contains a first component and a second component dispersed in the first component, wherein the second component increases in temperature by a lesser amount than the first component when a predetermined amount of heat is absorbed by the first and second components, respectively. According to one embodiment, the second component changes phase (e.g., from solid to liquid or from liquid to gas) in order to absorb the predetermined amount of heat without changing temperature. The second component could be the same substance as the first component, but provided in a different phase (e.g., solid-phase) than the first component (which would then be provided in a liquid-phase). Alternatively, the second component could be a different substance than the first component and also have a phase (e.g., solid) that is different from the phase (e.g., liquid) of the first component. The second component, whether it be the same or a different substance from the first component, can be held in or by holding members. According to a second embodiment, the second component of the coolant has a higher heat capacity than the first component. In this case, the second component need not change phase when it absorbs heat. Although the coolant of the second embodiment will exhibit a slight increase in temperature when it absorbs heat, the increase will be less than what would occur when the coolant was made up of the first component alone. In the second embodiment, the second component preferably is held by or in a holding member.

Furthermore, the linear motor in the above-mentioned respective embodiments was explained as a so-called moving magnet type linear motor in which a coil unit is a stator and a magnetic unit is a movable part, but it can also be applied to a moving coil type linear motor in which a coil unit is a movable part and a magnetic unit is a stator. In this case, a coil unit which is a movable part is connected to the stages PST, MST, and a magnetic unit which is a stator is arranged on the surface side (base) of the stages PST, MST.

Additionally, not only a semiconductor wafer for a semiconductor device, but also a glass substrate for a liquid display device, a ceramic wafer for a thin film magnetic head, an original of a mask or a reticle (composite quartz, silicon wafer) used in an exposure apparatus, or the like can be used as the photosensitive substrate P of the above-mentioned embodiments.

The exposure apparatus EX can be not only a step and scan type scanning type exposure apparatus which scans and exposes a pattern of the mask M by synchronously moving the mask M and the photosensitive substrate P, but also a step and repeat type projection exposure apparatus which exposes a pattern of the mask M in a state where the mask M and the substrate P are stationary and sequentially step-wise moves the photosensitive substrate P.

With respect to the types of the exposure apparatus EX, the invention can be widely applied to not only an exposure apparatus for manufacturing a semiconductor device which exposes a semiconductor device pattern onto a wafer but also an exposure apparatus for manufacturing a liquid display element which exposes a liquid display element pattern onto an angular glass plate, and an exposure apparatus which manufactures a thin film magnetic head, an imaging element (CCD), mask or the like.

Furthermore, as a light source of exposure illumination light, not only bright lines generated from a ultra high pressure mercury lamp (g-line (436 nm), h-line (404.7 nm), i-line (365 nm)), KrF excimer laser (248 nm), ArF excimer laser (193 nm), K₂ laser (157 nm) but also charged particle beams such as an X-ray, an electron beam, or the like can be used. For example, in the case of using an electron beam, thermionic emission type lanthanum hexaborate (LaB₆) and tantalum (Ta) can be used as an electron gun. Furthermore, in the case of using an electron beam, a structure can be used in which a mask M is used or a pattern is formed directly on a wafer without using a mask M. Furthermore, high frequency lasers or the like such as a YAG laser, a semiconductor laser, or the like can also be used.

As a projection optical system PL, when far ultraviolet rays such as an excimer laser or the like are used, materials which transmit far ultraviolet rays such as quartz, fluorite, or the like can be used. When an F₂ laser and an X-ray are used, a catadioptric system or a dioptric system can be used for an optical system (a reflective type mask M also is used). Furthermore, when an electron beam is used, the optical system can be an electron optical system which is formed of a deflector and an electron lens. Additionally, an optical path through which an electron beam passes is made to be a vacuum state. In addition, the invention can be applied to a proximity exposure apparatus which exposes a pattern of a mask M without using a projection optical system M, by contacting a mask M and a substrate P.

As stated in the above-mentioned embodiments, when a linear motor is used for a substrate stage PST and a mask stage MST, not only an air floating type linear motor using an air bearing, but also a magnetic floating type linear motor using Lorentz force can be used. Furthermore, the respective stages PST, MST can be of the type which moves along guides, or a guideless type which does not provide any guide.

As described in Japanese Laid-Open Patent Application 8-166475, a reaction force generated by the movement of the substrate stage PST can be transmitted to a floor (ground) by using a frame member. In addition, or alternatively, as described in Japanese Laid-Open Patent Application 8-330224, a reaction force generated by the movement of the mask stage MST can be transmitted to a floor (ground) by using a frame member.

Thus, the exposure apparatus EX of the embodiments of this invention is manufactured by assembling various subsystems including each structural element described herein in order to maintain specified mechanical, electrical, and optical accuracy. In order to ensure the various accuracies, before and after this assembly, adjustment is performed for achieving optical accuracy for various optical systems, adjusting is performed for achieving mechanical accuracy for various mechanical systems, and adjusting is performed for achieving electrical accuracy for various electrical systems. An assembly step from various subsystems to an exposure apparatus includes mechanical connection, wiring connection of an electrical circuit, pipe connection of an air pressure circuit, or the like of various subsystems. Before the assembly step of the various subsystems to form the exposure apparatus, individual assembly steps of each subsystem are performed. After the assembly steps for the exposure apparatus of various subsystems are completed, overall adjustment is performed, and various accuracies are ensured for the entire exposure apparatus. Additionally, it is preferable that an exposure apparatus is manufactured in a clean room in which a temperature, a degree of cleanliness, or the like is controlled.

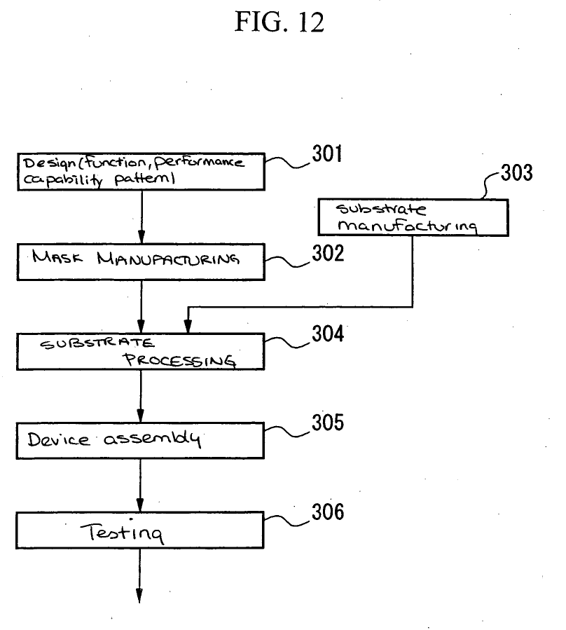

As shown in FIG. 12, a semiconductor device is manufactured through step 301 which performs function and performance capability design of the device, step 302 which manufactures a mask (reticle) based on the design step, step 303 which manufactures a substrate, substrate processing step 304 which exposes a pattern of the mask onto the substrate by the exposure apparatus EX of the above-mentioned embodiments, a device assembly step (including dicing step, bonding step, packaging step) 305, testing step 306, and the like.

Coils are the objects that are cooled by latent heat according to changes in a state of a cooling substance, so a cooling substance can cool coils without increasing in temperature. Therefore, the generation of a temperature distribution at each position of a linear motor device can be avoided, so the generation such as thermal deformation of a device and air fluctuation within the device can be avoided. Thus, high stage positioning accuracy and exposure processing accuracy can be accomplished.

While the invention has been described with reference to preferred embodiments thereof, it is to be understood that the invention is not limited to the preferred embodiments or constructions. To the contrary, the invention is intended to cover various modifications and equivalent arrangements. In addition, while the various elements of the preferred embodiments are shown in various combinations and configurations, which are exemplary, other combinations and configurations, including more, less or only a single element, are also within the spirit and scope of the invention.

1. A coolant comprising:
a first component; and
a second component held by holding members and dispersed in the first component, the second component changes phase in order to absorb a predetermined amount of heat.

2. (Cancelled)

3. The coolant according to claim 1, wherein the second component changes from a solid phase to a liquid phase in order to absorb the predetermined amount of heat.

4. The coolant according to claim 1, wherein second component is the same substance as the first component, and is provided in a different phase than the first component.

5. The coolant according to claim 1, wherein the second component is a different substance than the first component and is provided in a phase that is different from a phase of the first component.

6. (Cancelled)

7. The coolant according to claim 1, wherein the second component absorbs the predetermined amount of heat without changing temperature.

8. The coolant according to claim 1, wherein the second component has a higher heat capacity than the first component.

9-10. (Cancelled)

11. The coolant according to claim 8, wherein the second component is a gel.

12. (Cancelled)

13. The coolant according to claim 1, wherein the holding members are hollow with the second component located therein.

14. The coolant according to claim 1, wherein the holding members contain grooves with the second component located in the grooves.

15. The coolant according to claim 1, wherein the holding members contain pores with the second component located in the pores.

16. The coolant according to claim 1, wherein the holding members are formed of magnetic bodies.

17. The coolant according to claim 1, wherein the second component changes from a liquid phase to a gas phase in order to absorb the predetermined amount of heat.

18.-23. (Cancelled)

24. A method of cooling an object comprising:
circulating a coolant past the object, wherein the coolant includes a first component and a second component which is held by holding members and dispersed in the first component, the second component changes phase in order to absorb a predetermined amount of heat.

25. The method according to claim 24, further comprising removing heat from at least the second component after the coolant has been circulated past the object, so as to maintain the coolant at a predetermined temperature.

26. The method according to claim 25, wherein the step of removing heat from the second component changes the phase of the second component.

27. The method according to claim 26, wherein the second component changes from a solid phase to a liquid phase in order to absorb the predetermined amount of heat, and the step of removing heat from the second component changes the second component back into the solid phase.

28. The method according to claim 26, wherein second component is the same substance as the first component, and is provided in a different phase than the first component after the step of removing heat from the second component is performed.

29. The method according to claim 26, wherein the second component is a different substance than the first component and is provided in a phase that is different from a phase of the first component after the step of removing heat from the second component is performed.

30. (Cancelled)

31. The method according to claim 24, wherein the second component absorbs the predetermined amount of heat without changing temperature.

32. The method according to claim 24, wherein the second component has a higher heat capacity than the first component.

33.-34. (Cancelled)

35. The method according to claim 32, wherein the second component is a gel.

36. (Cancelled)

37. The method according to claim 24, wherein the holding members are hollow with the second component located therein.

38. The method according to claim 24, wherein the holding members contain grooves with the second component located in the grooves.

39. The method according to claim 24, wherein the holding members contain pores with the second component located in the pores.

40. The method according to claim 24, wherein the object to be cooled is a coil of a linear motor device having a housing with an internal space in which the coil is disposed, and a cooling system which cools the coil by circulating the coolant past the coil, the method further comprising:
mixing the second component with the first component; and
supplying the mixed coolant to the internal space of the housing using a pump.

41. The method according to claim 40, wherein the mixing includes setting a mixing ratio of the first component to the second component according to an amount of heat generated by the coil.

42. The method according to claim 40, wherein the linear motor device is part of a stage device.

43. The method according to claim 42, wherein the stage device is part of an exposure apparatus provided with a mask stage for holding a mask and a substrate stage for supporting a substrate, wherein the stage device is used for at least one of the mask stage and the substrate stage.

44. A cooling device, comprising:
a holding member, the holding member having at least one of a hollow part, a groove, and a pore; and
a cooling substance which absorbs an amount of heat due to a phase change between at least two of a solid phase, a liquid phase, and a gas phase, wherein the cooling substance is held in the at least one of the hollow part, the groove and the pore of the holding member.

45. The cooling device according to claim 44, wherein an internal pressure of the holding member is set based on a target phase change temperature of the cooling substance.

46. The cooling device according to claim 44, wherein the holding member is a magnetic body.

47. The cooling device according to claim 44, wherein the cooling substance is a gel.

48. A coolant, wherein the cooling device according to claim 44 is dispersed in a specified liquid.

49. The coolant according to claim 48, wherein the specified liquid is a different substance than the cooling substance.

50. The coolant according to claim 48, wherein the specified liquid is a same substance as the cooling substance.

51. The cooling device according to claim 44, wherein the holding member is provided with an internal space for holding at least the cooling substance, and a through-hole which connects an outside of the holding member and the internal space.

52. The cooling device according to claim 51, wherein the internal space is a hollow part formed inside the holding member and the cooling substance is held in the hollow part.

53. The cooling device according to claim 51, wherein the holding member is formed of a porous material, wherein the internal space is the space within at least one pore of the porous holding member and the holding member holds the cooling substance inside the pores.

54. A method of cooling an object, comprising:
holding a cooling substance with a holding member; and
dispersing the holding member in a specified liquid, wherein the cooling substance absorbs an amount of heat from a surrounding by undergoing a phase change between at least two of a solid phase, a liquid phase, and a gas phase to cool the object.

55. A method of cooling an object, comprising:
cooling the object by exposing the object to a coolant that is comprised of a specified liquid in which holding members are dispersed, the holding members having an internal space that is in communication with an outside of the holding members and a cooling substance located in the internal space, wherein the cooling substance absorbs an amount of heat from the object by undergoing a phase change between at least two of a solid phase, a liquid phase, and a gas phase.

56. The cooling method according to claim 55, wherein the cooling substance exists in at least two different ones of the solid state, the liquid state, and the gaseous state.

57. The cooling method according to claim 56, wherein the specified liquid is the cooling substance in the liquid state and the cooling substance held by the holding member is the cooling substance in the solid state.

58. The cooling method according to claim 56, wherein the coolant absorbs heat of the object without increasing a temperature of the cooling substance when the cooling substance in the solid state is changed to a liquid state.

59.-71. (Cancelled)

72. A coolant comprising:
a first component; and
a second component held by holding members and dispersed in the first component, the second component has a higher heat capacity than the first component.

73. The coolant according to claim 72, wherein the second component absorbs a predetermined amount of heat without changing temperature.

74. The coolant according to claim 72, wherein the second component does not change phase when the second component absorbs the predetermined amount of heat.

75. The coolant according to claim 72, wherein the second component is a gel.

76. The coolant according to claim 72, wherein the holding members are hollow with the second component located therein.

77. The coolant according to claim 72, wherein the holding members contain grooves with the second component located in the grooves.

78. The coolant according to claim 72, wherein the holding members contain pores with the second component located in the pores.

79. The coolant according to claim 72, wherein the holding members are formed of magnetic bodies.

80. A method of cooling an object comprising:
circulating a coolant past the object, wherein the coolant includes a first component and a second component which is held by holding members and dispersed in the first component, the second component has a higher heat capacity than the first component.

81. The method according to claim 80, further comprising removing heat from at least the second component after the coolant has been circulated past the object, so as to maintain the coolant at a predetermined temperature.

82. The method according to claim 80, wherein the second component is a gel.

83. The method according to claim 80, wherein the holding members are hollow with the second component located therein.

84. The method according to claim 80, wherein the holding members contain grooves with the second component located in the grooves.

85. The method according to claim 80, wherein the holding members contain pores with the second component located in the pores.

86. The method according to claim 80, wherein the object to be cooled is a coil of a linear motor device having a housing with an internal space in which the coil is disposed, and a cooling system which cools the coil by circulating the coolant past the coil, the method further comprising:
mixing the second component with the first component; and
supplying the mixed coolant to the internal space of the housing using a pump.

87. The method according to claim 86, wherein the mixing includes setting a mixing ratio of the first component to the second component according to an amount of heat generated by the coil.

88. The method according to claim 86, wherein the linear motor device is part of a stage device.

89. The method according to claim 88, wherein the stage device is part of an exposure apparatus provided with a mask stage for holding a mask and a substrate stage for supporting a substrate, wherein the stage device is used for at least one of the mask stage and the substrate stage.

90. A method of cooling a coil of a linear motor device having a housing with an internal space in which the coil is disposed, the method comprising:
circulating a coolant past the coil, wherein the coolant includes a first component and a second component dispersed in the first component, the second component has a higher heat capacity than the first component;
mixing the second component with the first component; and
supplying the mixed coolant to the internal space of the housing using a pump.

91. The method according to claim 90, wherein the mixing includes setting a mixing ratio of the first component to the second component according to an amount of heat generated by the coil.

92. The method according to claim 90, wherein the linear motor device is part of a stage device.

93. The method according to claim 92, wherein the stage device is part of an exposure apparatus provided with a mask stage for holding a mask and a substrate stage for supporting a substrate, wherein the stage device is used for at least one of the mask stage and the substrate stage.

94. A method of cooling a coil of a linear motor device having a housing with an internal space in which the coil is disposed, the method comprising:
circulating a coolant past the coil, wherein the coolant includes a first component and a second component dispersed in the first component, the second component changes phase in order to absorb a predetermined amount of heat;
mixing the second component with the first component; and
supplying the mixed coolant to the internal space of the housing using a pump.

95. The method according to claim 94, wherein the mixing includes setting a mixing ratio of the first component to the second component according to an amount of heat generated by the coil.

96. The method according to claim 94, wherein the linear motor device is part of a stage device.

97. The method according to claim 96, wherein the stage device is part of an exposure apparatus provided with a mask stage for holding a mask and a substrate stage for supporting a substrate, wherein the stage device is used for at least one of the mask stage and the substrate stage.
